(19) United States
(12) Patent Application Publication
(10) Pub. No.: US 2009/0127017 A1
(43) Pub. Date: May 21, 2009

(54) MOTOR VEHICLE

(76) Inventors: Andreas Hartmann, Holtinghausen (DE); Lutz Pydde, Damme (DE)

Correspondence Address: MCGLEW & TUTTLE, PC, P.O. BOX 9227, SCARBOROUGH STATION, SCARBOROUGH, NY, 10510-9227, US

(21) Appl. No.: 11/997,794

(22) PCT Filed: Jul. 27, 2006
(86) PCT No.: PCT/DE06/01310

§ 371 Date: Jun. 12, 2008

(30) Foreign Application Priority Data
Aug. 5, 2005 (DE) 10-2005-037-661.4

(51) Int. Cl. B60G 21/073

(52) U.S. Cl. 180/282

(57) ABSTRACT

A motor vehicle is provided with a vehicle body (2) and with a steering arrangement (15), which is connected to the vehicle body (2) and by means of which the motor vehicle (1) can be steered. At least two wheels (3, 4) are spring-mounted at the vehicle body (2) and are each connected to the vehicle body (2) via a hydraulic actuator. A switching unit (31) is coupled with the hydraulic actuators (7, 8) and by which the hydraulic actuators (7, 8) can be controlled or connected hydraulically in different ways. A control unit (23) is coupled hydraulically with the switching unit (31) and has an adjusting element (25), which is connected to the steering (15), can be moved by same and by which the switching unit (31) coupled hydraulically with the actuators (7, 8) is or can be hydraulically actuated for controlling or connecting the actuators (7, 8).

### CROSS REFERENCE TO RELATED APPLICATIONS

This application is a United States National Phase application of International Application PCT/DE2006/001310 and claims the benefit of priority under 35 U.S.C. § 119 of German Patent Application DE 10 2005 037 661.4 filed Aug. 5, 2005, the entire contents of which are incorporated herein by reference.

### FIELD OF THE INVENTION

The present invention pertains to a motor vehicle with a vehicle body; with a steering connected to the vehicle body, by means of which the motor vehicle can be steered; with at least two wheels, which are spring-mounted on the vehicle body and which are connected to the vehicle body via a hydraulic actuator each; and with a switching unit, which is coupled with the hydraulic actuators and by means of which the hydraulic actuators can be steered or connected hydraulically in different ways.

### BACKGROUND OF THE INVENTION

Motor vehicles, which have assembly units for the roll stabilization of the motor vehicle, are known from the state of the art. Conventional roll stabilizers connect, e.g., the two wheels of one axle. This leads to copying motions of the body during straight travel as a consequence of excitations from the road surface and impairs driving smoothness as a result. The cross-country mobility of off-road vehicles is limited because of a permanently acting roll stabilizer. In particular, the lack of torsional flexing may lead to losses of traction. Furthermore, systems for switchable uncoupling (switchable rocker pendulums, shifting claws in the stabilizer back) may be used, which use, e.g., a hydraulic unit for uncoupling the stabilizer. However, an electronic unit and a function software are used for this, which makes the system more expensive.

An absorption control device for a stabilizing bar is known from DE 196 54 562 A1, wherein an electronically controlled shock absorber is fastened to a suspension arm located under it and holds an end section of the stabilizing bar and exerts a force, which corresponds to a voltage applied, between the stabilizing bar and the suspension arm. An electronic control unit receives output signals from a vehicle velocity sensor as well as a steering angle sensor and actuates the shock absorber via the intermediary of a voltage amplifier.

A suspension system, in which a stabilizer, which is formed by a torsion bar, is connected to a left and right suspension arm each at its ends via an actuating member, is known from DE 199 40 420 A1. The apparent torsional rigidity of the stabilizer can be changed by the actuating member being provided at least on the left or right side of the stabilizer, so that it can extend or withdraw depending on the needs. A drive control for the actuating member has an electronic control unit, which receives output variables of a plurality of sensors, one of which is a steering angle sensor. The extent of tightness of a curve, in which the vehicle is traveling, is determined by detecting the transverse acceleration, but this can also be determined by calculating the transverse acceleration and the yaw rate from the steering angle and the velocity of the wheel or the vehicle. An electromagnetic linear actuating member of the type of a linear motor, a rotating electromagnetic actuating member or a conventional hydraulic component may be used as the actuating member.

### SUMMARY OF THE INVENTION

Based on this state of the art, the basic object of the present invention is to perfect a motor vehicle of the type mentioned in the introduction such that control of the actuators can be achieved without or with only a slight electronic effort.

The motor vehicle according to the present invention has a vehicle body; a steering, which is connected to the vehicle body and by means of which the vehicle can be steered; at least two wheels, which are spring-mounted on the vehicle body and which are connected to the vehicle body via a hydraulic actuator each; and a switching unit, which is coupled with the hydraulic actuators and by means of which the hydraulic actuators can be controlled or connected hydraulically in different ways. A switching unit is hydraulically coupled with the switching unit and has an adjusting element, which is connected to the steering, can be moved by the steering arrangement and by means of which the switching unit coupled hydraulically with the actuators can be or is hydraulically actuated for controlling or connecting the actuators.

An adjusting element connected to the steering is used in the motor vehicle according to the present invention to control the actuators or the characteristics thereof. The adjusting element, which is connected to the steering especially mechanically, acts hydraulically on the switching unit and actuates same to vary the actuator characteristics. Controlling of the actuators or changing their characteristics can thus be achieved purely mechanically and hydraulically, so that a complicated electronic control with sensors can be done away with. Controlling of the actuators or the characteristics thereof preferably takes place by the actuators being able to be connected or being connected hydraulically in different ways by means of the switching unit. Each wheel is mounted, in particular, movably, preferably pivotably via the corresponding actuator on the vehicle body. In particular, the spring rate for the spring-mounted wheels can be influenced by means of the actuators. Since the roll stabilization characteristics or roll characteristics of the motor vehicle can also be influenced via the characteristics of the actuators, controlled roll stabilization can also be achieved with the motor vehicle according to the present invention without a complicated electronic control. The actuators, the switching unit as well as the control unit with the adjusting element form a hydraulic actuator unit of the motor vehicle, which is coupled with the steering and is controlled or actuated by the latter.

The hydraulic coupling of the control unit with the switching unit is preferably uncoupled via the switching unit against feedback from the hydraulic couplings of the actuators with the switching unit, so that the control unit is coupled with the actuators without feedback. As a result, the influence of the actuators on the steering can be avoided or reduced. In particular, a plurality of hydraulic circuits can be embodied, the first hydraulic circuit coupling the control unit with the switching unit being separated by means of the switching unit from the other hydraulic circuits coupling the actuator or actuators with the switching unit in such a way that a hydraulic fluid present in the first hydraulic circuit cannot mix with a hydraulic fluid present in the other hydraulic circuit or hydraulic circuits. A hydraulic liquid is preferably used as the hydraulic fluid.

Depending on the control unit, the switching unit may assume different switching states, and the characteristics of the actuators can be varied between at least two different operating states. The two actuators are preferably separated for this from each other hydraulically in a first of the switching states by means of the switching unit and the two actuators are hydraulically coupled with one another via the intermediary of the switching unit in a second of the switching states. Hydraulic coupling of the two actuators with one another leads to different characteristics than when the two actuators are hydraulically uncoupled from each other. In particular, the two actuators mutually influence each other hydraulically in the second switching state and are hydraulically connected together hydraulically such that, e.g., rebound of one of the wheels also forces the other wheel to rebound and, e.g., inward deflection of one of the wheels also forces the other to perform an inward deflection. A wheel performing inward deflection or rebound actuates the actuator (e.g., as a hydraulic pump) connected to that wheel, which actuator drives the other actuator (as a final control element or motor), which will then cause the other wheel connected to same to perform an inward deflection or a rebound. Such a mutual hydraulic influence of the actuators on each other is prevented in the first switching state.

A hydraulic throttle each, which is coupled with the switching unit and via which the respective actuator is hydraulically short-circuited in the first switching state via the intermediary of the switching unit, is preferably connected to the actuators. It is possible by means of the throttles to set the absorption characteristics in the first switching state, a different absorption characteristic being able to be achieved especially for the pulling and pushing stage of each wheel. The term “pushing stage” is defined here as the inward deflection and the term “pulling stage” as the rebound of the corresponding wheel in relation to the vehicle body. In particular, absorption is greater in the pulling stage than the absorption in the pushing stage. For example, an approximately 30% greater absorption can be embodied for the pulling stage than in the pushing stage.

However, the actuators may also be short-circuited via the switching element without the intermediary of throttles in the first switching state. Furthermore, it is possible to completely stop the feed or removal of hydraulic fluid into or from each actuator. The actuators can form only a rigid connection between the wheels and the vehicle body in this case, which may, however, have a negative effect on driving smoothness. The actuators may also be coupled with one another without or via the intermediary of the throttles in the second switching state.

The switching unit preferably has a switching chamber, in which a control piston, which can be brought into different positions by the control unit, is mounted movably or guided displaceably, and which control piston hydraulically separates the actuators from each other in the first switching state and forms a hydraulic connection of the two actuators with one another or forms at least part of this connection in the second switching state. The control piston may be provided with a plurality of recesses or channels, the hydraulic fluid flowing through different channels depending on the switching state. Furthermore, the control piston forms especially a hydraulic connection (or a part thereof) between the respective throttle and the respective actuator in the first switching state, so that the two actuators are hydraulically short-circuited via the intermediary of the control piston and optionally of the respective throttle. Additional recesses or channels may be provided in the control piston for this connection.

The control unit preferably has a hydraulic chamber, which is filled especially with hydraulic fluid and in which a hydraulic piston forming the adjusting element is mounted movably or guided displaceably. The hydraulic chamber is preferably connected hydraulically to the switching unit or the control piston. Two hydraulic spaces, which are hydraulically coupled especially with the front sides of the control piston, may be formed between the hydraulic piston and the closed front sides of the hydraulic chamber.

The actuators may be designed as hydraulic linear actuators, e.g., as hydraulic linear absorbers and/or hydraulic linear motors. However, the actuators are preferably hydraulic rotary actuators, e.g., rotation absorbers and/or hydraulic swivel motors, which have a flat shape, contrary to linear actuators. The actuators may form hydraulic absorbers or pumps, which can preferably also be operated as hydraulic drives (motors) or final control elements. The actuator unit forms an absorber unit or an absorber-motor unit in this case. The absorption characteristics of the hydraulic actuators can now be varied by means of the switching unit, which is or can be hydraulically actuated or controlled by the adjusting element for this purpose.

To compensate temperature-related changes in the volume of the hydraulic fluid and/or losses due to leakage, at least one hydraulic reservoir may be hydraulically coupled with one of the actuators. However, both actuators are preferably connected hydraulically to a hydraulic reservoir each. The reservoirs can, furthermore, reduce or absorb hydraulic pressure peaks, especially when the two actuators or wheels are coupled with one another by the switching unit and thus act like a hydraulic capacity. The hydraulic fluid in the reservoir or reservoirs is especially under pressure. Furthermore, hydraulic pumps may be provided, which maintain the hydraulic fluid in the reservoir or reservoirs under pressure or feed hydraulic fluid to the reservoirs under pressure. The hydraulic pumps may be driven by the throttles or supplied with energy by same. It is also possible for the throttles themselves to have a pumping action or to be designed as pumps and especially to prestress the reservoir or the reservoirs especially automatically.

The control unit is preferably coupled hydraulically with the switching unit via a switchable hydraulic valve. The control unit can thus be hydraulically separated from the switching unit when needed. In particular, the coupling of the two actuators or wheels can be prevented by the hydraulic valve. This is utilized, e.g., when the steering is in the zero position and the vehicle is being operated off the road.

The two wheels are preferably connected to the vehicle body via a spring each, so that the wheels can be maintained at spaced locations from the vehicle body. Furthermore, the two wheels can be mounted pivotably at the vehicle body, especially by means of or via the intermediary of the actuators.

The two wheels are preferably provided on a common vehicle axle of the motor vehicle, which axle forms especially a steerable vehicle axle. The two wheels are or can be pivoted in this case by means of the steering in relation to the vehicle body. However, it is also possible that the two wheels are provided at a common, non-steerable vehicle axle. The motor vehicle preferably has in this case at least one additional, steerable vehicle axle, whose wheels are pivotable, especially in relation to the vehicle body, by means of the steering. Furthermore, it is possible to provide a plurality of vehicle axles of the motor vehicle with the actuator unit according to the present invention, of which especially at least one vehicle axle forms a steerable vehicle axle.

A torsion bar as a roll stabilizer can be done away with in the motor vehicle according to the present invention, because the actuator unit makes possible a roll stabilization controlled by the steering. The spring rate for the spring-mounted wheels can thus be reduced (by the dimension of the stabilizer spring), especially during straight travel or even permanently during off-road operation. Yet, it is possible to provide a torsion bar as an additional roll stabilizer, which preferably has soft spring characteristics.

Thus, the present invention describes a motor vehicle, which has an assembly unit or actuator unit, which is suitable for the roll stabilization of the motor vehicle. The actuator unit is characterized especially in that the conventional roll stabilizer has no effect during straight travel. The undesired copying is thus avoided. A rigidity can be switched on additionally during travel in curves in order to counteract rolling motions. The connection takes place especially via the hydraulic piston, which is preferably connected directly to the steering and drives or actuates the switching unit. It can be predetermined by the design of the switching unit that the additional rigidity will begin to act only beginning from a predetermined steering angle value or steering angle from the zero position, so that a hysteresis or hysteresis range can be obtained. This predetermined steering angle or steering angle value can especially be set and equals, e.g., ±3°. Furthermore, the zero position preferably represents a position of the steering wheel during straight travel of the motor vehicle. Within the hysteresis range, the wheels of the vehicle axle are guided independently from one another via the two throttles or a throttle package, with which the coordination of the absorber can be embodied for the pulling stage and the pushing stage for straight travel.

If the additional rigidity becomes necessary for compensating the rolling motion during travel in a curve (the steering angle being greater than the hysteresis), the actuators of one vehicle axle are coupled with one another. The respective reservoir can then be stressed further due to the slope of the vehicle during travel in a curve. If no reservoir is present, the system is nevertheless prestressed in the tubes or in the hydraulic lines. An elasticity is, in particular, always present, so that one can also speak of an “oil spring” or “hydraulic spring.” By contrast, absorption is preferably brought about via the throttles during straight travel.

In particular, the following advantages can be achieved with the present invention: A conventional roll stabilizer can be eliminated, as a result of which the design of the wheel suspension can be simplified. Furthermore, conventional linear actuators can be replaced by rotary actuators, which can be embodied with a flat design. Control arms and actuators may also be designed as one component. No sensor system and electronic system is necessary, unless a hydraulic valve is present or integrated and is switched electrically (e.g., in case of permanent uncoupling). Furthermore, permanent uncoupling of the wheels of one axle is possible (integrated off-road functionality).

The present invention will be described below on the basis of preferred embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the motor vehicle according to the present invention according to a first embodiment;

FIG. 2 is a schematic sectional view of the switching unit from FIG. 1 in a coupled state of the actuators;

FIG. 3 is a schematic sectional view of the switching unit from FIG. 1 in another coupled state of the actuators;

FIG. 4 is a schematic sectional view of the switching unit from FIG. 1 in an uncoupled state of the actuators;

FIG. 5 is a schematic sectional view of the control unit from FIG. 1;

FIG. 6 is a schematic view of an alternative, switchable valve; and

FIG. 7 is a schematic view of the motor vehicle according to the present invention according to a second embodiment.

### DESCRIPTION OF THE PREFERRED EMBODIMENTS

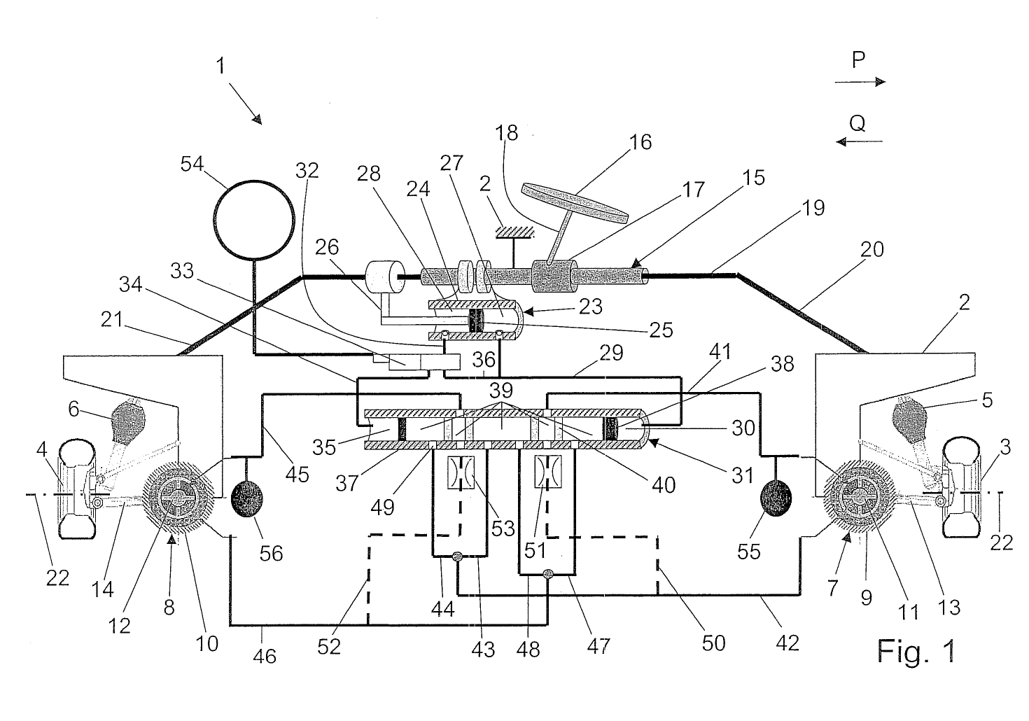

Referring to the drawings in particular, FIG. 1 shows a schematic view of a first embodiment of the motor vehicle according to the present invention, which is designated as a whole by 1. Two wheels 3, 4 are connected to a vehicle body 2 of the motor vehicle 1 via a respective spring 5, 6 each. Furthermore, two hydraulic rotary actuators 7, 8, which have each a housing 9, 10 and an inner part 11, 12 arranged therein, are fastened to the vehicle body 2. The inner parts 11, 12 are connected to the vehicle body 2 in such a way that they rotate in unison, whereas the housings 9, 10 are connected to a suspension arm 13, 14 in such a way that they rotate in unison. The inner parts 11, 12 are mounted rotatably in the respective housing 9, 10 and have a plurality of (e.g., four) radial wings each, between which chambers filled with hydraulic fluid are formed. The design of the actuators 7, 8 resembles, in particular, the design of a hydraulic swivel motor. Furthermore, the suspension arm 13 is articulated to wheel 3 and the suspension arm 14 to wheel 4.

A steering arrangement 15 connected to the vehicle body 2 has a steering wheel 16 and a steering gear 17, which is coupled with the steering wheel 16 via a steering shaft 18. A rack and pinion 19, which protrudes from a housing of the steering gear 17 on both sides and is displaceable in its longitudinal direction by means of a rotary motion of the steering wheel 16, is arranged in the steering gear 17. The rack and pinion 19 is connected to the wheel 3 by means of a track rod 20 and to the wheel 4 by means of a track rod 21, so that the two wheels 3, 4 are pivotable in relation to the vehicle body 2 by means of a rotary motion of the steering wheel 16. The two wheels 3, 4 are thus part of a steerable front axle 22 of the motor vehicle 1.

Even though the steering arrangement 15 is described here on the basis of a rack-and-pinion steering, it is, however, also possible to use another type of steering arrangement. The rack and pinion steering arrangement 15 is replaced in this case by a component that is movable by the steering wheel 16 or steering gear 17 and is connected to the wheels 3, 4 for pivoting the wheels 3, 4.

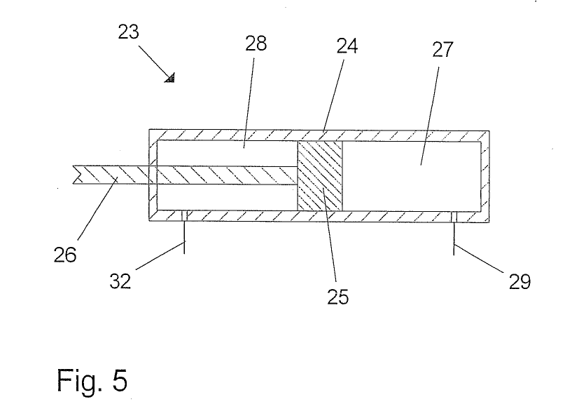

A control unit 23 has a hydraulic chamber 24, which is fastened to the housing of the steering gear 17 and in which a hydraulic piston 25 is guided displaceably. The hydraulic piston 25 is mechanically connected to the rack and pinion 19 by means of a mechanical connection, especially via a linkage 26 or another pull-push mechanism. The hydraulic chamber 24 is filled with a hydraulic fluid and is closed on the front side, the linkage 26 being guided displaceably through one of the front sides of the hydraulic chamber 24 and sealed against the front side (see FIG. 5). The piston 25 is sealingly in contact with the inner wall of the hydraulic chamber 24, so that hydraulic spaces 27, 28 filled with hydraulic fluid are formed between the piston 25 and the two front sides of the hydraulic chamber 24. The hydraulic space 27 is hydraulically connected via a hydraulic line 29 to a hydraulic space 30 in a switching unit 31. Furthermore, the hydraulic space 28 is hydraulically connected to a valve 33 via a hydraulic line 32. Valve 33 is connected via a hydraulic line 34 to a hydraulic space 35 in the switching unit 31. Furthermore, valve 33 is connected to the hydraulic line 29 via a hydraulic line 36.

The switching unit 31 has a switching chamber 37, in which a control piston 38 is guided displaceably. The switching chamber 37 is closed on the front side, so that the two hydraulic spaces 30 and 35 are formed between the front sides of the control piston 38 and the front sides of the switching chamber 37 (see FIG. 4).

The control piston 38 has a plurality of through holes 39, which are separated from one another by walls 40 and may be designed as holes, the walls 40 being formed by the material of the control piston 38. Furthermore, the holes 39 are separated from the hydraulic spaces 30 and 35 via the front sides of the control piston 38. As an alternative, the holes 39 may, however, also be completely or partially replaced by grooves in the outer circumferential surface of the control piston 38.

The actuator 7 or one of the chambers in the actuator 7 is connected to the switching unit 31 via a hydraulic line 41. Furthermore, the actuator 7 or another one of the chambers in the actuator 7 is connected to a hydraulic line 43 and to a hydraulic line 44 via a hydraulic line 42, the two hydraulic lines 43 and 44 being connected to the switching unit 31.

The actuator 8 or one of the chambers in the actuator 8 is connected to the switching unit 31 via a hydraulic line 45. Furthermore, the actuator 8 or another one of the chambers in the actuator 8 is connected via a hydraulic line 46 to a hydraulic line 47 and to a hydraulic line 48, the two hydraulic lines 47 and 48 being connected to the switching unit 31.

The hydraulic line 42 is connected, furthermore, to a hydraulic line 50, which is connected to the switching unit 31 via the intermediary of a hydraulic throttle 51. Furthermore, the hydraulic line 46 is connected to a hydraulic line 52, which is connected to the switching unit 31 via the intermediary of a hydraulic throttle 53.

The control lines 41, 43, 44, 45, 47, 48, 50 and 52 are connected to the interior space of the switching chamber 37 at different points via through holes 49 provided in the wall of the switching chamber 37.

The control unit 23, the valve 33, as well as the hydraulic lines 29, 32, 34 and 36 form a first hydraulic circuit with the hydraulic spaces 30 and 35 via the intermediary of the control piston 38, the valve 33 being connected such that the hydraulic line 32 is connected to the hydraulic line 34 and the hydraulic line 36 is closed by the valve 33. If the steering wheel 16 is rotated in one direction, so that the rack and pinion 19 is moving together with the piston 25 in the direction of arrow P, hydraulic fluid is pressed out of the hydraulic space 27 and through the hydraulic line 29 into the hydraulic space 30. As a result, the control piston 38 is displaced in the direction of arrow Q, so that hydraulic fluid flows out of the hydraulic space 35 into the hydraulic space 28 through the hydraulic line 34, through the valve 33 and through the hydraulic line 32. If the steering wheel 16 is rotated in the opposite direction, so that the rack and pinion 19 and the hydraulic piston 25 are moving in a direction opposite arrow P, the control piston 38 is displaced in a direction opposite the direction indicated by arrow Q. The displacement of the control piston 38 always takes place relative to the switching chamber 37.

The first hydraulic circuit is uncoupled from the actuators 7, 8 via the switching unit 31 in such a way that hydraulic fluid of the first hydraulic circuit cannot exchange or mix with hydraulic fluid of the actuators 7, 8. Furthermore, the switching unit 31 prevents feedback from the actuators 7, 8 to the first hydraulic circuit, because the hydraulic fluid of the actuators 7, 8 cannot displace the control piston 38. This is achieved especially by the hydraulic fluid of the actuator 7, 8 flowing at right angles to the direction of motion of the control piston 38 into and out of the switching chamber 37.

In the position of the control piston 38 shown in FIG. 1, the actuator 7 is hydraulically short-circuited via the hydraulic lines 41, 50 and 42 via the intermediary of throttle 51. The hydraulic line 50 or the throttle 51 is in connection now with the hydraulic line 41 via one of the holes 39 in the control piston 38. Furthermore, the actuator 8 is hydraulically short-circuited via the hydraulic lines 45, 52 and 46 via the intermediary of throttle 53, the hydraulic line 52 or the throttle 53 being in connection with the hydraulic line 45 via another one of the holes 39 of the control piston 38. These two actuators 7 and 8 are thus hydraulically uncoupled from one another.

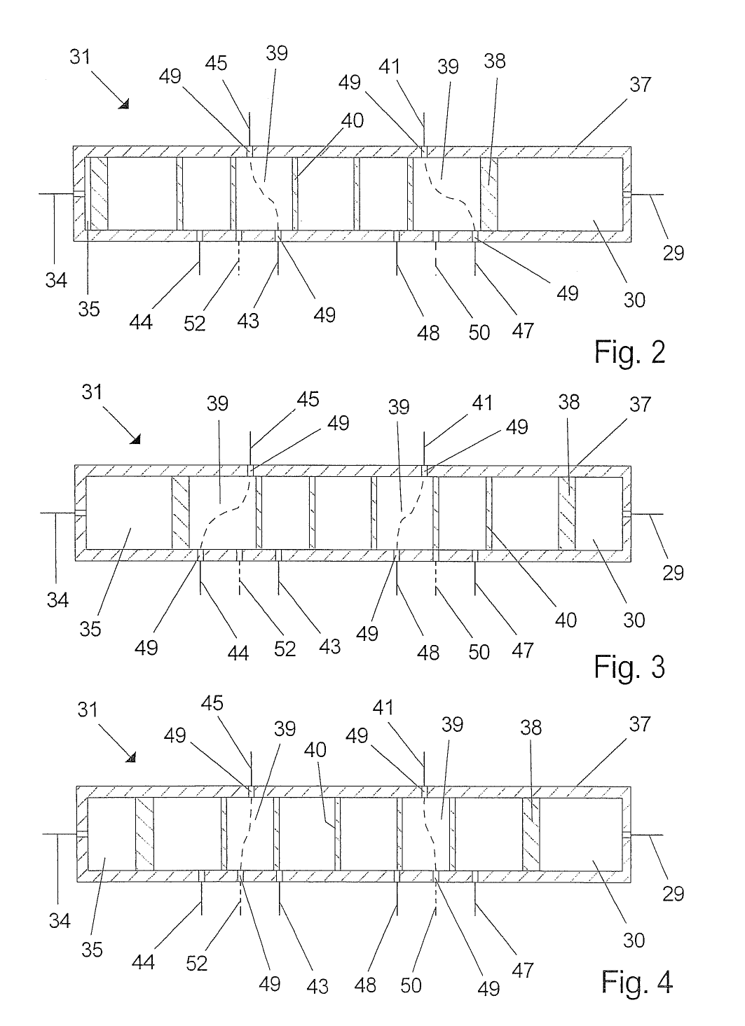

FIG. 2 shows a schematic view of the switching unit 31 in a coupled state of the actuators 7, 8, wherein the control piston 38 is displaced in the direction of arrow Q. The hydraulic line 41 is connected in this case to the hydraulic line 47 via one of the holes 39. Furthermore, the hydraulic line 45 is connected to the hydraulic line 43 via another one of the holes 39, so that the two actuators 7, 8 are hydraulically coupled with one another. This hydraulic coupling of the two actuators 7, 8 is preferably carried out such that roll stabilization or stabilization of the yaw characteristic of the motor vehicle 1 is achieved.

FIG. 3 shows a schematic view of the switching unit 31 in another coupled state of the actuators 7, 8, where the control piston 38 is displaced in a direction opposite the direction of arrow Q. The hydraulic line 41 is connected in this case to the hydraulic line 48 via one of the holes 39. Furthermore, the hydraulic line 45 is connected to the hydraulic line 44 via another one of the holes 39, so that the two actuators 7, 8 are hydraulically coupled with one another. This hydraulic coupling of the two actuators 7, 8 is preferably brought about such that roll stabilization or stabilization of the roll angle of the motor vehicle 1 is achieved.

FIG. 4 shows a schematic view of the switching unit 31 in an uncoupled state of the actuators 7 and 8, which corresponds to the state of the switching unit 31 shown in FIG. 1. Furthermore, FIG. 5 shows a schematic view of the control unit 23.

Valve 33 in FIG. 1 can be actuated via a switch 54 and it can thus be switched over. The hydraulic line 32 is connected to the hydraulic line 36 in the switched-over state, whereas the hydraulic line 34 is closed by valve 33. The control piston 38 of the switching unit 31 cannot be adjusted by the control unit 23 any longer in this state. The switched-over state can now be switched on preferably only if the two actuators 7, 8 are uncoupled from one another. Relative to the embodiment, this means that the switched-over state can be switched on especially only when the control piston 38 is in the position according to FIG. 1 or 4.

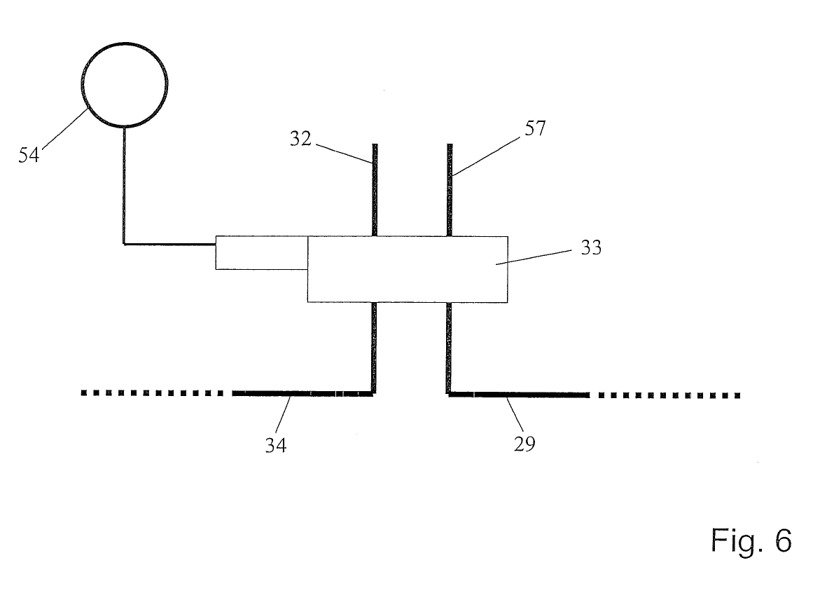

FIG. 6 shows an alternative embodiment of valve 33, wherein the hydraulic line 29 connected to the hydraulic space 30 is connected hydraulically to the hydraulic space 27 via the intermediary of valve 33 and a hydraulic line 57. Valve 33 can be switched over by means of switch 54 such that the two hydraulic lines 32 and 57 and hence also the two hydraulic spaces 27 and 28 are connected hydraulically to one another, whereas the two lines 29 and 34 are closed by valve 33.

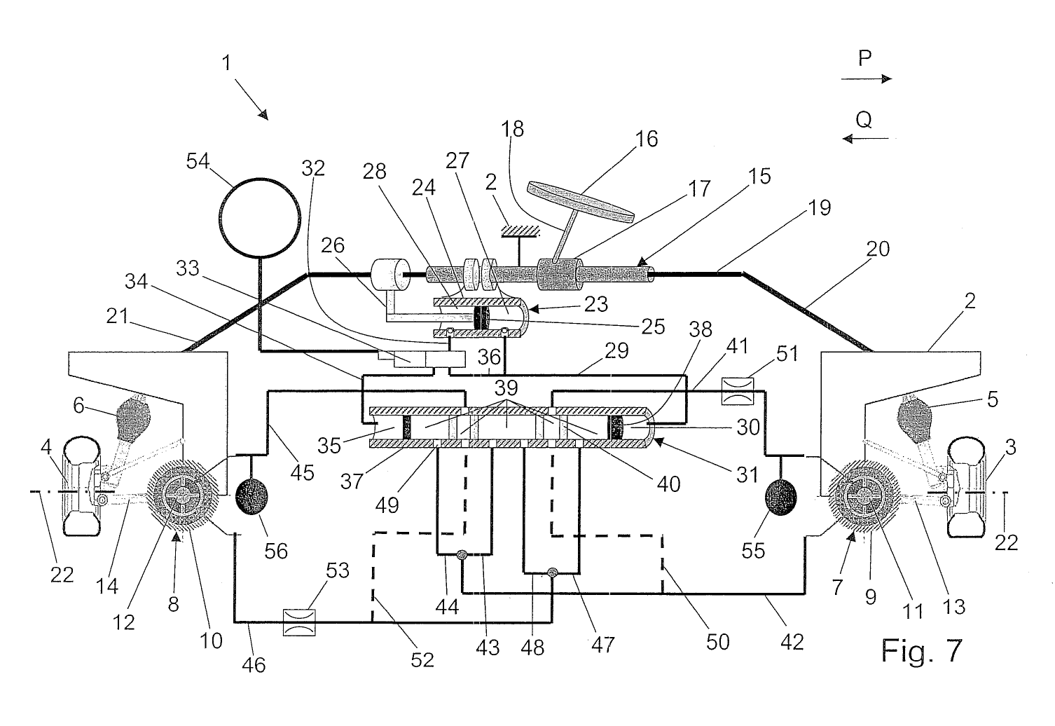

FIG. 7 shows a schematic view of a second embodiment of the motor vehicle according to the present invention, wherein identical or similar features are designated by the same reference numbers as in the first embodiment. The second embodiment differs from the first embodiment only in that the hydraulic throttles 51 and 53 are connected into the hydraulic lines 41 and 46 rather than into the hydraulic lines 50 and 52. The actuators 7, 8 are thus coupled with one another in the coupled state via the intermediary of the throttles 51, 53, so that the flow of hydraulic fluid (oil flow) is also throttled during travel in a curve.

While specific embodiments of the invention have been shown and described in detail to illustrate the application of the principles of the invention, it will be understood that the invention may be embodied otherwise without departing from such principles.

1-12. (canceled)

13. A motor vehicle comprising:
a vehicle body;
a steering arrangement connected to said vehicle body, said steering arrangement for steering the motor vehicle;
two wheels spring-mounted at said vehicle body;
hydraulic actuators, said two wheels each being connected to said vehicle body via one of said hydraulic actuators;
a switching unit coupled with said hydraulic actuators for controlling and hydraulically connecting said hydraulic actuators in different ways;
a control unit coupled hydraulically with said switching unit, said control unit having an adjusting element connected to said steering arrangement and being moved by said steering arrangement, said control unit for coupling said switching unit hydraulically with said actuators, said control unit being actuated hydraulically for controlling or connecting said actuators.

14. A motor vehicle in accordance with claim 13, wherein said adjusting element is mechanically coupled with said steering arrangement.

15. A motor vehicle in accordance with claim 13, wherein said control unit is coupled with said actuators via said switching unit without feedback.

16. A motor vehicle in accordance with claim 13, wherein different switching states can be assumed by said switching unit including a first switching state in which said two actuators are uncoupled from one another hydraulically by means of said switching unit and a second switching state in which said two actuators are hydraulically coupled with one another via the intermediary of said switching unit.

17. A motor vehicle in accordance with claim 16, further comprising hydraulic throttles connected to said actuators, each of said hydraulic throttles being coupled with said switching unit, said actuators being respectively hydraulically short-circuited via said hydraulic throttles in the first switching state via the intermediary of said switching unit.

18. A motor vehicle in accordance with claim 16, wherein said switching unit has a switching chamber, in which a control piston is guided movably, said control piston being set into different positions by said control unit and said control piston hydraulically separating said actuators from each other in said first switching state and said control piston hydraulically connecting said actuators via the intermediary of recesses provided in said control piston in the second switching state.

19. A motor vehicle in accordance with claim 18, wherein said actuators are hydraulically short-circuited via the intermediary of said recesses provided in said control piston in said first switching state.

20. A motor vehicle in accordance with claim 13, wherein said control unit has a hydraulic chamber, in which a hydraulic piston forming said adjusting element is guided displaceably, said hydraulic chamber being hydraulically connected to said switching unit.

21. A motor vehicle in accordance with claim 13, wherein said two actuators each comprise hydraulic swivel motors.

22. A motor vehicle in accordance with claim 13, further comprising hydraulic reservoirs wherein said actuators are each hydraulically coupled with one of said hydraulic reservoirs.

23. A motor vehicle in accordance with claim 13, wherein said control unit is hydraulically coupled with said switching unit via a switchable hydraulic valve.

24. A motor vehicle in accordance with claim 13, wherein said two wheels can be pivoted by said steering arrangement in relation to said vehicle body.

25. A motor vehicle comprising:
a vehicle body;
a steering means for steering the motor vehicle, said steering arrangement being connected to said vehicle body;
a first wheel spring-mounted at said vehicle body;
a second wheel spring-mounted at said vehicle body, said first wheel and said second wheel being pivoted by said steering means in relation to said vehicle body;
a first hydraulic actuator, said first wheel being connected to said vehicle body via said first hydraulic actuator;
a second hydraulic actuator, said second wheel being connected to said vehicle body via said second hydraulic actuator;
a switching unit coupled with said first hydraulic actuator and said second hydraulic actuator for controlling and hydraulically connecting said first hydraulic actuator and said second hydraulic actuator in different ways;
a control unit coupled hydraulically with said switching unit, said control unit having an adjusting element connected to said steering means and being moved by said steering means, said control unit for coupling said switching unit hydraulically with said actuators, said control unit being actuated hydraulically for controlling or connecting said actuators.

26. A motor vehicle in accordance with claim 25, wherein said adjusting element is mechanically coupled with said steering arrangement and said control unit is coupled with said actuators via said switching unit without feedback.

27. A motor vehicle in accordance with claim 26, wherein different switching states can be assumed by said switching unit including a first switching state in which said two actuators are uncoupled from one another hydraulically by means of said switching unit and a second switching state in which said two actuators are hydraulically coupled with one another via the intermediary of said switching unit.

28. A motor vehicle in accordance with claim 27, further comprising hydraulic throttles connected to said actuators, each of said hydraulic throttles being coupled with said switching unit, said actuators being respectively hydraulically short-circuited via said hydraulic throttles in the first switching state via the intermediary of said switching unit.

29. A motor vehicle in accordance with claim 28, wherein said switching unit has a switching chamber, in which a control piston is guided movably, said control piston being set into different positions by said control unit and said control piston hydraulically separating said actuators from each other in said first switching state and said control piston hydraulically connecting said actuators via the intermediary of recesses provided in said control piston in the second switching state.

30. A motor vehicle in accordance with claim 29, wherein said actuators are hydraulically short-circuited via the intermediary of said recesses provided in said control piston in said first switching state.

31. A motor vehicle in accordance with claim 25, wherein said two actuators each comprise hydraulic swivel motors and further comprising hydraulic reservoirs wherein said actuators are each hydraulically coupled with one of said hydraulic reservoirs.

32. A motor vehicle in accordance with claim 25, wherein said control unit is hydraulically coupled with said switching unit via a switchable hydraulic valve.
